(19) United States
(12) Patent Application Publication
(10) Pub. No.: US 2005/0025896 A1
(43) Pub. Date: Feb. 3, 2005

(54) Thermal spray metal on low heat resistant substrates

(76) Inventors: Grigoriy Grinberg, Sylvania, OH (US); Matthew M. Shade, Plymouth, MI (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/631,870

(22) Filed: Aug. 1, 2003

(51) Int. Cl. H05H 1/26

(52) U.S. Cl. 427/446

(57) ABSTRACT

Method for thermal spraying a metal stream onto a low heat resistant substrate using an adhesive/release promoted interface with the metal stream and the articles so produced for use in various applications.

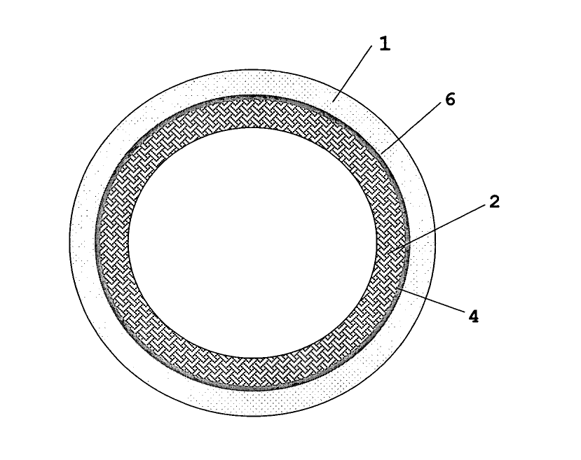

### FIELD OF THE INVENTION

The invention relates to a method of thermal spraying a stream of high melting point metal onto an low heat resistant substrate, such as wood, plastic, foam, rapid prototype and similar materials. The metal-adhesive process can be used to metalize parts and other articles for various applications.

### BACKGROUND OF THE INVENTION

Examples of thermal spray methods that are useful for producing metal coated parts are arc wire spray, flame spray, HVOF, plasma spray, D-gun, cold spray and the like. Generally a method used to apply a metal coating on a low temperature substrate consists of applying a layer of metal filled epoxy to the substrate then machining the epoxy and then applying a thermal spray material. This method is time consuming and can leave defects in the surface. Other alternatives for this problem are vacuum metalizing, metal sleeves, covers or electroplating.

The use of zinc alloy has been sprayed on such low heat resistant materials, however, the resulting tool formed is relatively soft. It is known that pseudo-alloy can be thermally sprayed on low heat resistant materials such as wood, plastic and the like to produce a tool that is relatively hard compared to zinc layered low heat resistant materials.

Thermal metal spray requires a large energy input, which is typically manifest as heat energy, to moltenize and make the metal sprayable. Because of the high temperature of the metal when it strikes the substrate (part/component), the substrate has typically been required to be constructed from high heat material, such as metal or ceramic, in order to survive the spraying of such molten metal.

It is an object of the present invention to provide a new process for spraying metal directly on a low heat resistant substrate thereby eliminating the conventional multi-step process using metal filled epoxy applied before the thermal spray process or using high temperature substrates or plating or vacuum metalizing.

### SUMMARY OF THE INVENTION

In at least one embodiment, the present invention relates to a method for applying a high melting point thermal spray material onto a substrate having a distortion temperature below the temperature of the hot coating material at the surface of the substrate comprising:
(a) applying an adhesive promoter layer on at least a portion of the substrate selected from the group comprising wax, wood, plastic, foam, plaster, epoxy and composites; and
(b) applying a thermal spray material onto the adhesive promoter layered substrate and said thermal spray material having a temperature at the surface of said adhesive promoter layered substrate below the temperature at which the substrate would distort so that the coated material will have effectively the same contour as the adhesive promoter layer substrate. A distorting temperature is a temperature at which the substrate distorts by less than 0.001 inch.

Preferably, for most applications, after step (a) a layer of a bonding material, such as zinc, copper, nickel, chrome, molybdenum, aluminum, compounds thereof and alloys thereof, is applied to the adhesive promoter layered substrate to increase the bonding and increase the adhesive characteristics of the material in step (b). The adhesive promoter should be a material that has an adequate thermal and chemical characteristics that are compatible with the sprayed material and not effectively reduce surface contour and details of the low heat resistant substrate. For other applications, the adhesive promoter may be a release agent so that the substrate can be removed from the metal sprayed deposit. Suitable adhesive and release agents can be selected from the group comprising epoxies, silicones, urethanes, cyanoacrylates, polyvinyl acetate (PVA) and the like. Suitable solvents can be used to create a better tacky surface. The preferred adhesives are polyurethane, polyvinyl acetate (PVA) and, epoxies. For most applications, the thickness of the adhesive layer can vary between 0.0001 inch and 0.020 inch, preferably between 0.0005 inch 0.005 inch. The bonding layer, if required, is applied to provide better adhesion and increase the bonding for the thermal spray material. The thermal spray material can be applied with a high gun-to-substrate linear velocity to balance the thermal input to the substrate. High linear velocity will create thin low stress layers. Typically the linear velocity is greater than 0.5 m/s or a power input factor from 0.5 to 45 watts/mm. The lower the melting point of the substrate will require the linear speed of the spray to be increased. The thickness of the coated layers could be between 00001 inch and 1.0 inch, preferably between 0001 inch and 002 inch. The material of the coated layer is preferably metal and can be selected from the group consisting of nickel, steel, stainless steel, chrome, tungten, aluminum, alloys thereof, pseudoalloys thereof, and compounds thereof.

In preferred applications, the adhesive promoter material would not be a release agent but have good adhesive characteristics that would bond and secure the outer spray layer to provide a finish article. For example, the finish article could be selected from the group comprising printing polls (ucarlox), aircraft skins, electronic circuit boards, any plastic or composite part exposed to wear or erosion.

Essentially, almost any metal or alloy which can be made into wire can be arc wire sprayed, including steels, nickel, copper and aluminum. From a practical standpoint, the current spray metal process utilizes zinc. Materials with melting points higher than this (770° F. or 410° C.) overheat most conventional substrates and distort, crack or warp upon application. Zinc, on the other hand, when applied, has unique characteristics which reproduce the substrate surface exactly, has low shrinkage or warpage, maintains a temperature warm to the touch, and can be applied at rates up to five square feet of pattern per hour. If a softer surface is produced (melting point 400° F. or 204° C.) then in some cases this could limit the application to which the part can be used, especially where higher temperatures and pressures are required.

The Arc Wire Spray gun is similar in size and appearance to those used for paint spraying. Wires are fed automatically. Although metal particles impacting the surface are in a molten state, a significant characteristic is that the substrate undergoes only a small temperature rise. The system is very simple to use, 3 KVA of power and 35 cfm of 80 psi compressed air are supplied to preset automatic controls which essentially eliminate operator judgment relative to spraying parameters. Once the electric system is energized only one button is pushed to start and stop the preset rate of wire feed. The power supply automatically maintains the proper wire intersection geometry by maintaining the arc voltage constant to give a consistent controllable spray jet with a cone diameter of approximately three inches at an eight-inch standoff distance. All systems are generally made up of modular units which can be interchanged in a number of permutations and combinations. A system can be simply altered on a tailor-made basis to provide optimal coatings with any material of interest. When making a sprayed metal layer the Arc Wire Spray gun can operate in the range of 25 to 1500 amps at 20 to 40 volts. The spray rate depends on amperage, which is essentially power, since the voltage is constant. When spraying small pieces, or when starting (to achieve the best surface texture) high pressures are used. The constant voltage power supply automatically increases or decreases the amperage to track wire feed rate, thereby, keeping wire tip melt geometry constant. The wires tend to move closer together when the wire feed rate is increased. This feature maintains a constant atomization characteristic and a uniform metal particle size distribution and spray pattern. The spray rate can be measured by reading the amperage. At 100 amps, 20 lbs/hr of zinc is melted, as the amperage is increased or decreased proportionately more or less is melted.

### BRIEF DESCRIPTION OF THE DRAWINGS

The invention will be described with reference to the accompanying drawing which is a cross-section view showing a composite printing roll with high melting point metal. The spray metal thickness for printing rolls can preferably be from 0.0001 to 1.0 inch.

### DESCRIPTION OF THE PREFERRED EMBODIMENT

As shown in the drawing, the basic steps of the method comprise:
(a) preparing a suitable part (substrate) having a low heat resistant fiber reinforced material such as carbon fiber 2.
(b) applying an adhesion promoter 4 to the surface of the part. This is required to assure adhesion of the first coat of sprayed metal. PVA's have been found most satisfactory for most applications. The adhesion agent must have adequate thermal and chemical characteristics to be compatible with the sprayed metal and not dramatically reduce surface detail. The adhesive should be applied carefully to produce a uniformly thin film.
(c) allowing the adhesive to dry for a few minutes or while slightly tacky depending on the adhesive, and then spraying the adhesive surface with a sprayed metal 6 (bondcoat), such as a nickel-chrome material. The first bondcoat is, obviously, the most critical because it is this coat which serves as the bond surface. The bondcoat 6 is normally accomplished at a low spray rate of 50 amps (2 to 10 lbs/hr) and care is taken to assure that the entire surface is coated. Once the first surface coat of 0.005 inch is achieved, the spray rate can be up to 36 lbs/hr depending upon the type of spray material and the size of the surface to be sprayed. In all cases, during the entire spraying process care must be taken to assure that the surface does not become overheated. On small parts, to eliminate overheating, compressed air or a cooling gas is allowed to blow on the part to facilitate cooling. Spraying continues until 0.060 inch of metal 8 or some other thickness is achieved. In some cases, parts have been sprayed up to 0.5 inch thick for additional strength. Thicknesses less than 0.030 inch are not usually recommended because of inadequate strength while with thicknesses much above 0.2 inch could result in minor distortion and stresses to develop.

For better adhesive for the top coat, a bonding material can be deposited over the adhesive layer. Preferably the thickness of the bonding material (layer) is between about 0.0005 inch ands about 0.050 inch and more preferably about 0.005 inch. Preferably the bonding material is selected from the group comprising zinc, nickel, steel, chromium, aluminum and alloys of such materials.

Zinc is the preferred material because of its melting point, expansion characteristics, hardness and cost. If the zinc surface, as produced, is not compatible with the application, nickel or aluminum can be used to improve adhesion in some applications.

Other variations of the disclosed method are within the intended scope of this invention as claimed below. As previously stated, detailed embodiments of the present invention are disclosed herein; however, it is to be understood that disclosed embodiments are merely exemplary of the invention that may be embodied in various forms.

1. A method for applying a high melting point material thermally sprayed onto a substrate having a distortion temperature below the temperature of the thermal spray material at the surface of the substrate comprising:
(a) preparing a substrate with a contour of a desired shape;
(b) applying an adhesive promoter layer on at lesat a portion of the substrate; and
(c) applying a thermal spray material onto the adhesive promoter layer wherein said thermal spray material having a temperature at the surface of the adhesive promoter coated substrate below the temperature at which the substrate would distort so as to provide a material coated layer surface having the contour as the design shape of the substrate.

2. The method of claim 1 wherein the thermal spray material is a metal selected from the group comprising steels, stainless steels, nickel, chromium, tungsten, aluminum, alloys thereof, pseudoalloys thereof and compounds thereof.

3. The method of claim 1 wherein the adhesive promoter is selected from the group comprising epoxies, silicones, urethanes, cyanoacrylates, and polyvinyl acetate.

4. The method of claim 3 wherein the thickness of the adhesive promoter is between about 0.0001 inch and about 0.020 inch.

5. The method of claim 2 wherein the thickness of the metal is between about 0.0001 inch and about 1 inch.

6. The method of claim 2 wherein the part substrate is selected from the group comprising wax, wood, plastic, foam, plaster, epoxy and composites.

7. The method of claim 2 wherein the metal is steel, the adhesive promoter is a polyvinyl acetate and the substrate is fiber composite.

8. The method of claim 7 wherein the thickness of the adhesive promoter is between about 0.0001 inch and about 0.020 inch.

9. The method of claim 7 wherein the thickness of the metal is between about 0.001 inch and about 1 inch.

10. A metal coated substrate made using the method of claim 1.

11. The metal coated substrate of claim 10 wherein the said metal coated substrate is a printing roll.

12. The method of claim 1 wherein after step (b) the adhesive promoter coated layer substrate is coated with a bonding layer.

13. The method of claim 12 wherein the bonding layer has a thickness between about 0.0005 inch and about 0.050 inch.

14. The method of claim 13 wherein the bonding layer is selected from the group comprising zinc, nickel, steel, chromium, aluminum, and alloys of such materials.

15. The method of claim 1 wherein the adhesive promoter is a releasable agent.

16. The method of claim 15 wherein the releasable agent is polyvinyl acetate.

17. The method of claim 15 wherein after step (b) the adhesive promoter coated layer substrate is coated with a bonding layer.

18. The method of claim 15 wherein the substrate is selected from the group comprising wax, wood, plastic, epoxy and composites.

19. The method of claim 18 wherein the thickness of the adhesive promoter is between about 0.0001 inch and about 0.020 inch.

20. The method of claim 19 wherein the thickness of the metal is between about 0.0001 inch and about 1 inch.
